(19) United States
(12) Patent Application Publication
(10) Pub. No.: US 2012/0122350 A1
(43) Pub. Date: May 17, 2012

(54) BOARD-TO-BOARD-TYPE CONNECTOR

(75) Inventors: Yoon Sik Choi, Gwangju (KR); Young Ryeol Cho, Gwangju (KR)

(73) Assignee: HUMAN ELECTRONICS CO., LTD., Gwangju (KR)

(21) Appl. No.: 13/381,421

(22) PCT Filed: Jun. 28, 2010
(86) PCT No.: PCT/KR2010/004171

§ 371 Date: Feb. 1, 2012

(30) Foreign Application Priority Data
Jun. 29, 2009 (KR) 10-2009-0058272
Sep. 22, 2009 (KR) 10-2009-0089808

(51) Int. Cl. H01R 24/20

(52) U.S. Cl. 439/660

(57) ABSTRACT

Disclosed is a board-to-board-type connector including: a female connector holder having an upper surface with an engagement opening with which a plurality of female terminals are engaged in symmetrical rows; and a male connector holder having an upper rim from which an engagement protrusion protrudes such that a plurality of male terminals are arranged in symmetrical rows and engaged with the engagement protrusion to form electrical contact with the female terminals, the male connector holding being fitted to the engagement opening of the female connector holder, wherein the female terminal includes a U-shaped receiving portion accommodated in the engagement opening and first stopper protrusions protruding toward an inside of the engagement opening from intermediate portions of both side surfaces of the receiving portion, the male terminal includes a U-shaped insertion portion formed along an outer peripheral surface of the engagement protrusion and second stopper protrusions symmetrically protruding toward an outside direction of the engagement protrusion from intermediate portions of both side surfaces of the insertion portion, and the female terminal is attached/detached to/from the male terminal by elastic deformation of the first stopper protrusions and the second stopper protrusions. Consequently, the board-to-board-type connector of the present invention is configured such that the female terminals are symmetrically deformed in the left and right directions when the female terminals are attached/detached to/from the male terminals. Thus, stresses being applied to the female terminals during attachment/detachment are distributed in the left and right directions, and therefore the engagement between the female terminals and the male terminals is stably maintained even when the connector is used over a long period of time.

### CROSS-REFERENCE TO RELATED APPLICATION

This application claims priority to and the benefit of Korean Patent Application No. 2009-0058272, filed on Jun. 29, 2009 and No. 2009-0089808, filed on Sep. 22, 2009, the disclosure of which is incorporated herein by reference in its entirety.

### BACKGROUND

1. Field of the Invention

The present invention relates to a board-to-board-type connector, and more particularly to a board-to-board-type connector, in which symmetric stopper protrusions are formed in both a female terminal and a male terminal forming electrical contact to improve the engagement between the female terminal and the male terminal and stress applied to the female terminals is distributed in left and right directions, so that an electrical contact state between the female terminal and the male terminal can be stably maintained even when the board-to-board-type connector is used over a long period of time.

2. Discussion of Related Art

Generally, an electrical connector used in an electrical and electronic industry is a means for electrically connecting two or more electrical components and its use frequency has been further increased according to the development of the electrical and electronic industry. This is especially true when it is difficult to integrally manufacture two or more components or when a separate manufacturing of two or more components is more efficient.

Such an electrical connector includes a female connector holder including a plurality of female terminals and a male connector holder including a plurality of male terminals, and the female terminals and the male terminals maintain a stable contact state through physical engagement of the female connector holder and the male connector holder, making it possible to always flow a constant current.

A detailed construction of the electrical connection having the aforementioned construction and function is disclosed in Document 1 in detail, and Document 1 is especially related to a board-to-board-type connector for electrically connecting a pair of boards.

That is, as illustrated in FIGS. 1 and 2, the board-to-board-type connector includes a female connector holder 20 engaged with a plurality of female terminals 22 arranged in symmetrical rows and a male connector holder 10 engaged with a plurality of male terminals 12 arranged in symmetrical rows.

In this case, the female connector holder 20 and the male connector holder 10 are physically engaged with each other, and when the female connector holder 20 and the male connector holder 10 are physically engaged with each other, the female terminal 22 and the male terminal 12 form electrical contact.

To this end, the male terminal 12 has a U-shaped insertion portion 12a inserted to the female terminal 22 and the female terminal 22 has a U-shaped receiving portion 22c to which the insertion portion 12a is fitted. The insertion portion 12a is physically fitted to the receiving portion 22c, making it possible to stably maintain the electrical contact of the female terminal 12 and the male terminal 22.

However, the conventional board-to-board-type connector is configured such that one side portion 22c2 of the female terminal 22 is elastically deformed to form electrical contact with the male terminal 12, so that it has an advantage of easy engagement between the female terminal 22 and the male terminal 12 with a small force, but has a problem of easy separation of the engagement between the female terminal 22 and the male terminal 12 by a small impact.

Further, since stresses by deformation applied to the female terminals 22 and the male terminals 12 during attachment/detachment of the female terminals 22 and the male terminals 12 are concentrated only to the one side portion 22c2 of the female terminal 22, elasticity at the deformed portions is deteriorated when the connector is used for a long time, so that it is impossible to stably maintain the electrical contact between the female terminals 22 and the male terminals 12.

Further, the conventional board-to-board-type connector is configured such that one side portion 22c2 of the female terminal 22 is deformed by protrusions 12d1 and 12d2 asymmetrically formed in the male terminal 12 and a protrusion 22d formed in one side of the female terminal 22 so that the female terminal 22 is engaged with the male terminal 12. Accordingly, the conventional board-to-board-type connector has a disadvantage of the deterioration of a click feeling at the moment of the engagement.

Accordingly, since a user cannot accurately identify whether the female terminals 22 are normally engaged with the male terminals 12, the user may use the electrical product in a state in which the electrical contact between the boards is poor, thereby causing malfunction and damage of the electrical product.
[Document 1] Korea Patent Publication No. 2007-0116706 (published on Dec. 1, 2007)

### SUMMARY OF THE INVENTION

The present invention has been made in an effort to solve the above-described problems associated with the prior art, and an object of the present invention is to provide a board-to-board-type connector having an engagement structure of female terminals and male terminals requiring a small force for the engagement of the female terminals and the male terminals, but requiring a relatively large force for the separation of the female terminals and the male terminals.

Another object of the present invention is to provide a board-to-board-type connector, which distributes stress applied to the female terminals when the female terminals are attached/detached to/from the male terminals, so that it is possible to stably maintain an electrical contact state between the female terminals and the male terminals even when the board-to-board-type connector is used for a long time.

Further, another object of the present invention is to provide a board-to-board-type connector, which improves a click feeling when the female terminals are engaged with the male terminals, thereby enabling the user to accurately identify whether the female terminals are normally engaged with the male terminals.

According to an aspect of the present invention for achieving the above object, there is provided a board-to-board-type connector including: a female connector holder having an engagement opening in an upper surface with which a plurality of female terminals are engaged in symmetrical rows; and a male connector holder having an upper rim from which an engagement protrusion protrudes such that a plurality of male terminals are arranged in symmetrical rows and engaged with the engagement protrusion to form electrical contact with the female terminals, the male connector holder being fitted to the engagement opening of the female connector holder, wherein the female terminal includes a U-shaped receiving portion accommodated in the engagement opening and first stopper protrusions symmetrically protruding toward an inside of the engagement opening from intermediate portions of both side surfaces of the receiving portion, the male terminal includes a U-shaped insertion portion formed along an outer peripheral surface of the engagement protrusion and second stopper protrusions symmetrically protruding toward an outside direction of the engagement protrusion from intermediate portions of both side surfaces of the insertion portion, and the female terminals are attached/detached to/from the male terminals by elastic deformation of the first stopper protrusions and the second stopper protrusions.

Preferably, the first stopper protrusion has a first inclination portion of which a height protruding from an entrance of the receiving portion in an insertion direction of the insertion portion gradually increases and a second inclination portion which is extended from the first inclination portion and of which a height protruding in the insertion direction gradually decreases, and widths between contact points of the first inclination portions and the second inclination portions are narrower than a width between both side surfaces of the insertion portion, and a gradient of the second inclination portion is larger than that of the first inclination portion.

Preferably, a space is formed between an inside wall surface of the engagement opening and the receiving portion such that the first stopper protrusions can be easily deformed when the female connector holder is fitted to the male connector holder.

Preferably, the both side surfaces of the receiving portion are connected to a bottom surface of the receiving portion by inclination surfaces so as to buffer a shock due to deformation of the first stopper protrusions.

Preferably, the second stopper protrusion has a third inclination portion of which a height protruding in the insertion direction of the insertion portion gradually increases, a straight contact portion which is extended from the third inclination portion in a direction parallel to the both side surfaces of the insertion portion, and a fourth inclination portion which connects the straight contact portion and a bottom surface of the insertion portion and of which a height protruding in the insertion direction gradually decreases, and when the female connector holder is fitted to the male connector holder, electrical contacts are formed between the both side surfaces of the receiving portion and the straight contact portions of the second stopper protrusions and between the first stopper protrusions and the both side surfaces of the insertion portion.

Preferably, the female terminal further includes female terminal fixing portions extended from both ends of the receiving portion and engaged with first fixing grooves formed in both sides of the engagement opening and a female terminal welding portion perpendicular to the female terminal fixing portions and formed toward an outside of the female connector holder, and the female terminal welding portion is connected to an end of one side of the female terminal fixing portion through a first welding inclination portion and a width of the first welding inclination portion is narrower than a width of the female terminal welding portion and a width of the female terminal fixing portion.

Preferably, the female terminal fixing portion includes at least one first wedge-type protrusion in each of both sides thereof for preventing the female terminal from being separated from the female connector holder, and in order to guide an end of an opposite side of the female terminal fixing portion which is not connected with the female terminal welding portion to the first fixing groove when the female terminal is engaged with the female connector holder, a size of a cross-sectional area of the end of the opposite side of the female terminal fixing portion gradually decreases in an engagement direction.

Preferably, the male terminal further includes male terminal fixing portions extended from both ends of the insertion portion and engaged with second fixing grooves formed in both sides of the engagement protrusion and a male welding portion perpendicular to the male terminal fixing portions and formed toward the outside of the male connector holder, and the male terminal welding portion is connected to an end of one side of the male terminal fixing portion through a second welding inclination portion and a width of the second welding inclination portion is narrower than a width of the male terminal welding portion and a width of the male terminal fixing portion.

Preferably, the male terminal fixing portion includes at least one second wedge-type protrusion in each of both sides thereof for preventing the male terminal from being separated from the male connector holder, and in order to guide an end of an opposite side of the male terminal fixing portion which is not connected to the male terminal welding portion to the second fixing groove when the female terminal is engaged with the female connector holder, a size of a cross sectional area of the end of the opposite side of the male terminal fixing portion gradually decreases in an engagement direction.

Preferably, each of the engagement opening and the engagement protrusion has a □-shape, and a curve or a straight chamfer for guiding the engagement protrusion to the engagement opening when the female connector holder is fitted to the male connector holder is formed in a rim of the engagement opening with which the female terminals are not engaged or a rim of the engagement protrusion with which the male terminals are not engaged.

Preferably, stepped portions are vertically and inwardly formed in outside surfaces of the female connector holder with which the female terminals are not engaged and outside surfaces of the male connector holder with which the male terminals are not engaged, respectively.

Preferably, the male connector holder has escaping grooves in an inside bottom surface of the male connector holder for accommodating deformation of the female terminals when the female connector holder is fitted to the male connector holder.

Preferably, the first stopper protrusions protrude from the outside surfaces of both sides of the receiving portion toward inside surfaces of each of the outside surfaces of the receiving portion such that the first stopper protrusions symmetrically face each other through a bending, an embossing, or a slitting processing, and the second stopper protrusions protrude from the inside facing surfaces of the insertion portion toward the outside surfaces of both sides of the insertion portion such that the second stopper protrusions symmetrically face each other through a bending, an embossing, or a slitting processing, and the female terminal comes into contact with the male terminal by elastic deformation of the receiving portion and the insertion portion, wherein the first stopper protrusions come into contact with the insertion portion and the second stopper protrusions come into contact with the receiving portion.

In this case, the second stopper protrusion has a third inclination portion of which a height protruding in the insertion direction of the insertion portion gradually increases, a straight contact portion which is extended from the third inclination portion in a direction parallel to the both side surfaces of the insertion portion, and a fourth inclination portion which connects the straight contact portion and of which a height protruding in the insertion direction gradually decreases to have a wedge shape, and a gradient of the fourth inclination portion is identical to that of the first inclination portion, and electrical contacts are formed between the inside surfaces of the receiving portion and the straight contact portions of the second stopper protrusions and between the first stopper protrusions and the both side surfaces of the insertion portion when the female connector holder is fitted to the male connector holder.

Preferably, when the first stopper protrusions are engaged with the second stopper protrusions by the engagement of the female terminals and the male terminals, the first inclination portions of the first stopper protrusion are in contact and symmetrically engaged with the fourth inclination portions of the second stopper protrusion.

Preferably, the first stopper protrusion and the second stopper protrusion have incision portions formed by a slitting processing such that both side surfaces of the first stopper protrusion and the second stopper protrusion are interconnected.

As described above, the a board-to-board-type connector according to the present invention is configured such that a gradient of the first stopper protrusion formed in the female terminal in a separation direction of the male terminal is larger than a gradient in an insertion direction of the male terminal, so that a larger force is required in the separation of the female terminals from the male terminal than the engagement of the female terminals with the male terminals, thereby stably maintaining the engagement state of the female terminals and the male terminals.

Further, the a board-to-board-type connector according to the present invention has a construction in which the female terminal is symmetrically tensioned in both side directions when the female terminal is attached/detached to/from the male terminal, so that stress applied to the female terminal is distributed to the both side directions, and thus it is possible to stably maintain the engagement state of the female terminals and the male terminals.

Furthermore, the a board-to-board-type connector according to the present invention improves a click feeling through elastic deformation and restoration of the receiving portion and the insertion portion symmetrically formed in the female terminal and the male terminal, respectively, when the female terminals are engaged with the male terminals, thereby enabling the user accurately to identify whether the female terminals are normally engaged with the male terminals.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIGS. 1 and 2 are cross-sectional views illustrating a male connector holder and a female connector holder included in the conventional board-to-board-type connector, respectively;

FIGS. 3 and 4 are perspective views illustrating a female connector holder and a male connector holder included in a board-to-board-type connector according to a first embodiment of the present invention, respectively;

FIG. 5 is a perspective view illustrating an engagement state of the female connector holder and the male connector holder;

FIGS. 6 and 7 are perspective views illustrating female terminals and male terminals of a board-to-board-type connector according to a first embodiment of the present invention, respectively;

FIG. 8 is a view illustrating a state just before an engagement of the female terminals and the male terminals;

FIG. 9 is a cross-sectional view illustrating an engagement of the female terminals and the male terminals;

FIGS. 10 and 11 are perspective views illustrating a female connector holder and a male connector holder included in a board-to-board-type connector according to a second embodiment of the present invention, respectively;

FIG. 12 is a perspective view illustrating an engagement state of the female connector holder and the male connector holder;

FIG. 13A is a perspective view illustrating an example of female terminals of a board-to-board-type connector according to a second embodiment of the present invention and FIG. 13B is a perspective view illustrating another example of FIG. 13A;

FIG. 14A is a perspective view illustrating an example of male terminals of a board-to-board-type connector according to a second embodiment of the present invention and FIG. 14B is a perspective view illustrating another example of FIG. 14A;

FIG. 15 is a view illustrating a state just before an engagement of the female terminals and the male terminals of a board-to-board-type connector according to a second embodiment of the present invention; and

FIG. 16 is a cross-sectional view illustrating an engagement of the female terminals and the male terminals of a board-to-board-type connector according to a second embodiment of the present invention.

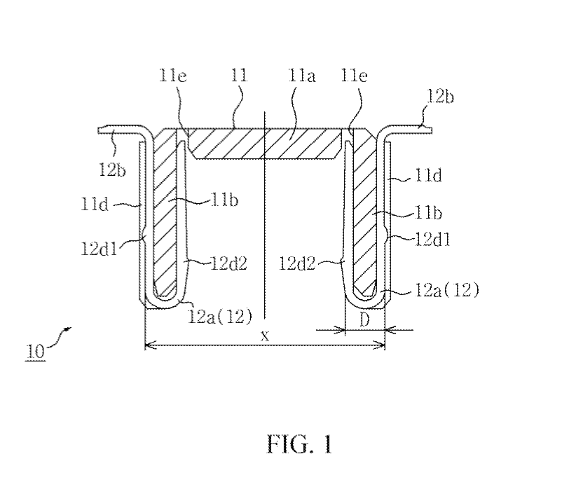

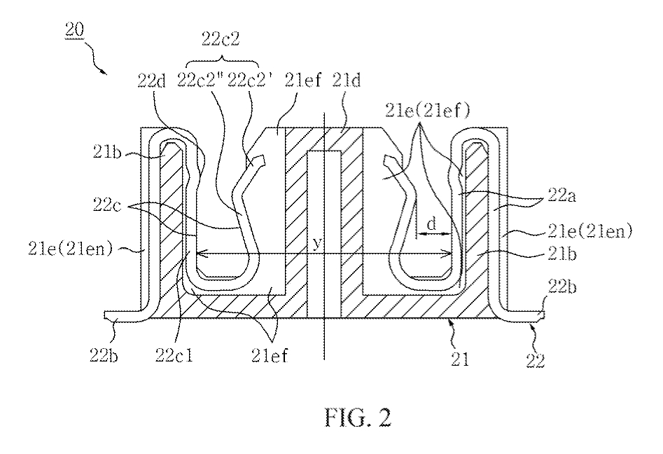

### DETAILED DESCRIPTION OF EXEMPLARY EMBODIMENTS

Hereinafter, an exemplary embodiment of a board-to-board-type connector according to the present invention will be described below in detail with reference to the accompanied drawing.

The present invention may be representatively applied to a narrow-pitch board-to-board-type micro connector.

### First Embodiment

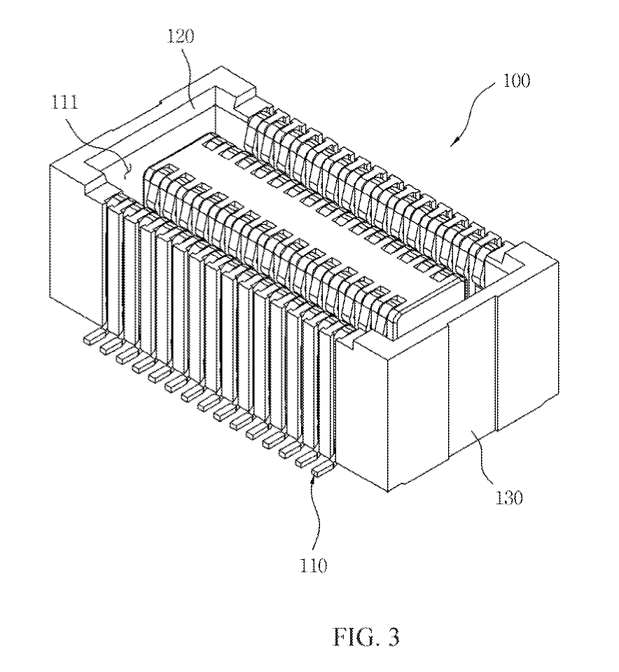

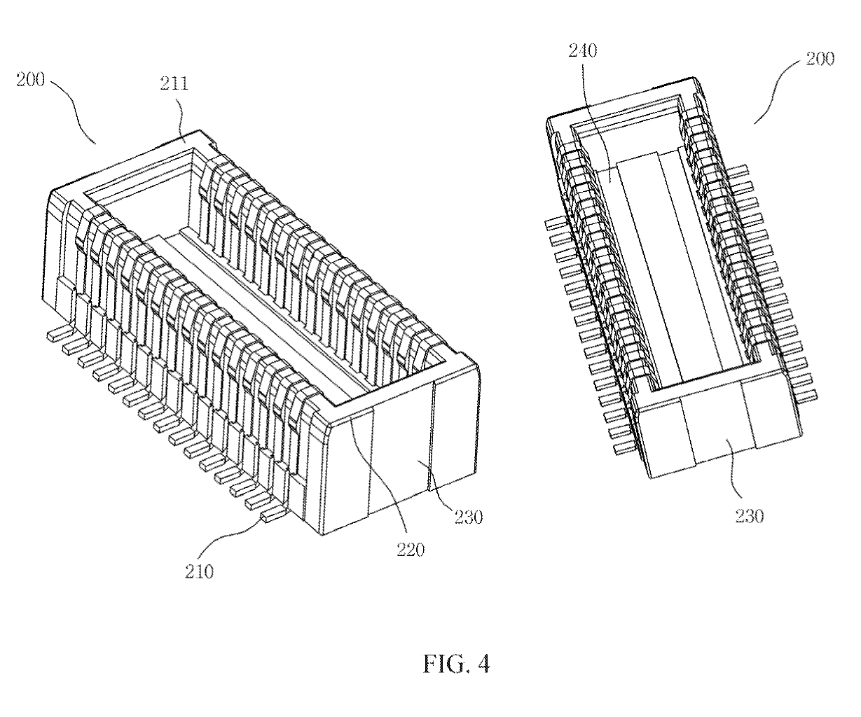

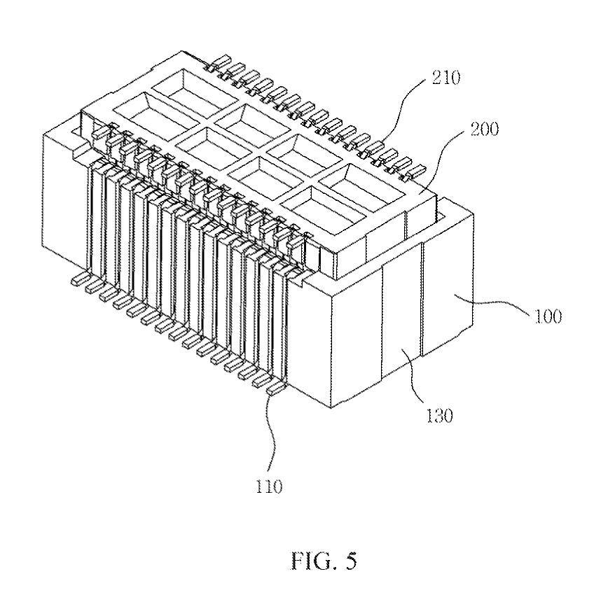

FIGS. 3 and 4 are perspective views illustrating a female connector holder 100 and a male connector holder 200 included in a board-to-board-type connector according to a first embodiment of the present invention, respectively, and FIG. 5 is a perspective view illustrating an engagement state of the female connector holder 100 and the male connector holder 200.

As illustrated in FIGS. 3 to 5, the board-to-board-type connector according to the present invention includes the female connector holder 100 engaged with a plurality of female terminals 110 and the male connector holder 200 engaged with a plurality of male terminals 210.

In this case, the female connector holder 100 has a □-shaped opening 111 vertically formed in an upper surface thereof in a lower direction and the plurality of female terminals 110 are engaged with the engagement opening 111 in left and right directions.

Further, the male connector holder 200 has a □-shaped engagement protrusion 211, which protrudes from an upper rim of an upper surface of the male connector holder 200 and is fitted to the engagement opening 111. The engagement protrusion 211 is engaged with the plurality of male terminals 210, which form electrical contact with the respective female terminals 110, in left and right directions.

Further, guide portions 120 and 220 for easily guiding the engagement protrusion 211 to the engagement opening 111 when the engagement protrusion 211 is fitted to the engagement opening 111 are formed in at least one of the rim of the engagement opening 111 with which the female terminals 110 are not engaged and the rim of the engagement protrusion 211 with which the male terminals 210 are not engaged. The guide portions 120 and 220 are preferably formed in a curve or a straight chamfer.

Further, stepped portions 130 and 230 are vertically and inwardly formed in an outside surface of the female connector holder 100 with which the female terminals 110 are not engaged and an outside surface of the male connector holder 200 with which the male terminals 210 are not engaged, respectively.

In this case, the stepped portions 130 and 230 are used for control of positions of the female connector holder 100 and the male connector holder 200 when the female connector holder 100 is engaged with the male connector holder 200, and also serves to prevent burrs of a gate which may be generated in an injection molding from protruding to the outside.

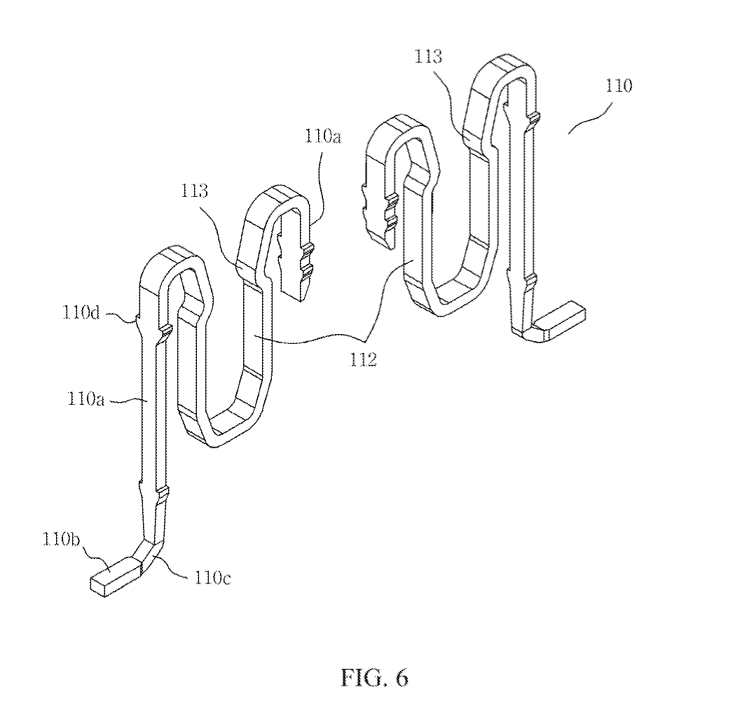

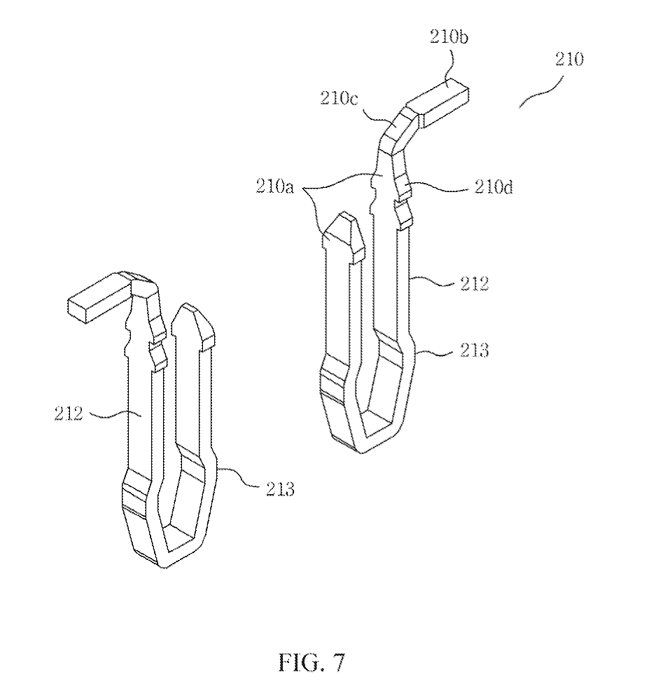

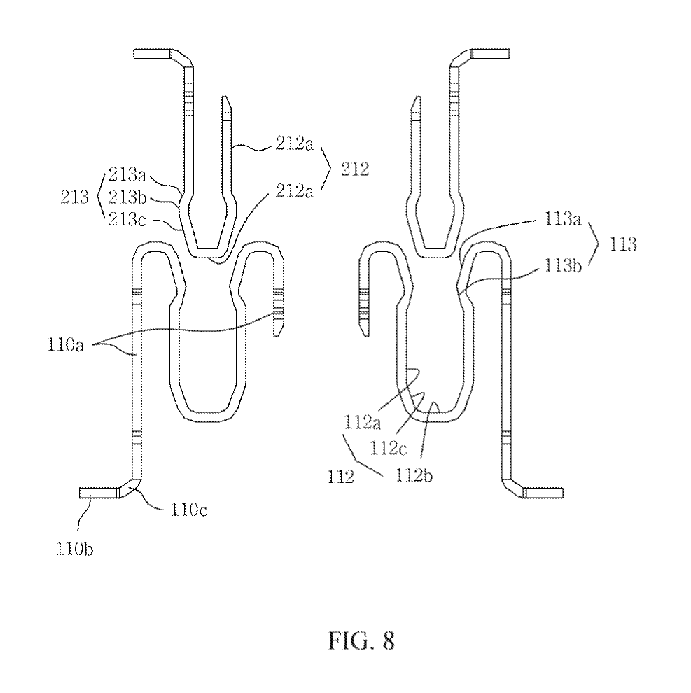

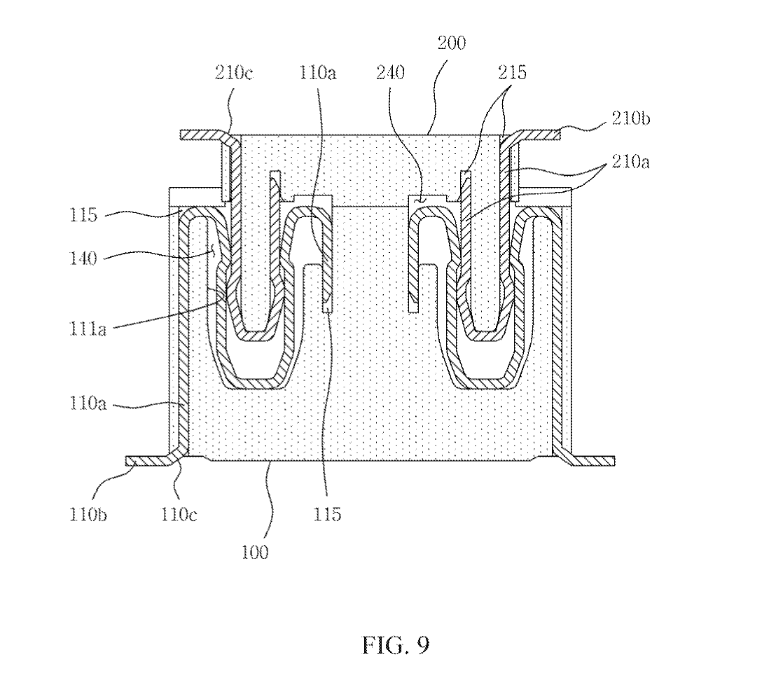

FIGS. 6 and 7 are perspective views illustrating the female terminals 110 and the male terminals 210 of the board-to-board-type connector according to the first embodiment of the present invention, respectively, FIG. 8 is a view illustrating a state just before an engagement of the female terminals 110 and the male terminals 210, and FIG. 9 is a cross-sectional view illustrating an engagement of the female terminals 110 and the male terminals 210.

The female terminal 110 included in the board-to-board-type connector according to the present invention has a U-shaped receiving portion 112 accommodated in the engagement opening 111, first stopper protrusions 113 symmetrically protruding toward the inside of the engagement opening 111 from intermediate portions of both side surfaces of the U-shaped receiving portion 112, female terminal fixing portions 110a extended from both ends of the receiving portion 112 and engaged with first fixing grooves 115 formed in both sides of the engagement opening 111, and a female terminal welding portion 110b perpendicular to the female terminal fixing portions 110a and formed toward the outside of the female connector holder 100.

Further, the first stopper protrusion 113 has a first inclination portion 113a of which a height protruding from an entrance of the receiving portion 112 to be described later in an insertion direction of an insertion portion 212 gradually increases, and a second inclination portion 113b which is extended from the first inclination portion 113a and of which a height protruding in the insertion direction gradually decreases.

In this case, a gradient of the second inclination portion 113b is larger than that of the first inclination portions 113a. Through the construction, the board-to-board-type connector according to the present invention requires a small force when the female terminals 110 are engaged with the male terminals 210, but requires a relatively large force when the female terminals 110 are separated from the male terminals 210, so that it is possible to stably maintain the engagement state of the female terminals 110 and the male terminals 210.

The male terminal 210 includes a U-shaped insertion portion 212 formed along an outer peripheral surface of the engagement protrusion 211, second stopper protrusions 213 symmetrically protruding toward the outside of the engagement protrusion 211 from the intermediate portions of both side surfaces of the insertion portion 212, male terminal fixing portions 210a extended from both ends of the insertion portion 212 and engaged with second fixing grooves 215 formed at both sides of the engagement protrusion 211, and a male terminal welding portion 210b perpendicular to the male terminal fixing portion 210a and formed toward the outside of the male connector holder 200.

Further, the second stopper protrusion 213 includes a third inclination portion 213a of which a height protruding in the insertion direction of the insertion portion 212 gradually increases, a straight contact portion 213b extended from the third inclination portion 213a in a direction parallel to both side surfaces 212a of the insertion portion, and a fourth inclination portion 213c which connects the straight contact portion 213b and a bottom surface 212b of the insertion portion and of which a height protruding in the insertion direction gradually decreases.

In this case, it is preferable that a gradient of the fourth inclination portion 213c is formed to be identical or similar to that of the first inclination portion 113c formed in the female terminal 110, so that the insertion portion 212 is inserted into the inside of the receiving portion 112 with a small force when the female terminal 110 is engaged with the male terminal 210.

Through the aforementioned construction, the female terminals 110 and the male terminals 210 of the board-to-board-type connector according to the present invention are attached/detached to/from each other by elastic deformation of the symmetrically formed first stopper protrusions 113 and second stopper protrusions 213.

That is, when the female terminal 110 is engaged with the male terminal 210, the bottom surface 212b and the fourth inclination portions 213c of the male terminal 210 are naturally guided toward the inside of the receiving portion 112 along the first inclination portions 113a of the female terminal 110, so that the first stopper protrusions 113 of the female terminal 110 are widened in left and right directions, and when the second stopper protrusions 213 are completely inserted to the inside of the receiving portion 112, the first stopper protrusions 113 return to their original positions by elasticity.

A width between contact points of the first inclination portions 113a and a width between contact points of the second inclination portions 113b of the first stopper protrusions 113 are narrower than a width between both side surfaces 212a of the insertion portion, so that when the second stopper protrusions 213 pass through the first stopper protrusions 113, the first stopper protrusions 113 widened toward side directions impact with both side surfaces 212a of the insertion portion while instantly returning to their original positions by elasticity.

Therefore, the click feeling when the female terminals 110 are engaged with the male terminals 210 is improved by impact sound, so that a user can advantageously identify whether the female terminals 110 are normally engaged with the male terminals 210.

Further, when the female terminal 110 is separated from the male terminal 210, the third inclination portions 213a of the male terminal 210 are guided along the second inclination portions 113a having a relatively large gradient, so that the separation of the female terminal 110 from the male terminal 210 requires a larger force than a force required for the engagement of the female terminal 110 and the male terminal 210. As a result, the board-to-board-type connector according to the present invention can stably maintain the engagement state of the female terminals 110 and the male terminals 210.

Further, the board-to-board-type connector according to the present invention has a construction in which the female terminals 110 are symmetrically deformed in left and right directions when the female terminals 110 are attached/detached to/from the male terminals 210, so stresses applied to the female terminals 110 when the female terminals 110 are attached/detached to/from the male terminals 210 are distributed in the left and right directions.

Accordingly, since stresses applied to each of the first stopper protrusions 113 are greatly decreased compared to the conventional art, elasticity of the female terminals 110 and the male terminals 210 is advantageously maintained when the board-to-board-type connector is used for a long time, so that the electrical contact between the female terminal 110 and the male terminal 210 is stably maintained.

Further, the width between the straight contact portions 213b is formed to be identical to or slightly larger than a width between both side surfaces 112a of the receiving portion, so that the board-to-board-type connector according to the present invention may doubly form electrical contact between both side surfaces 112a of the receiving portion and the straight contact portions 213b of the second stopper protrusion 213 and between the first stopper protrusions 113 and both side surfaces 212a of the insertion portion.

Both side surfaces 112a of the receiving portion are connected to a bottom surface 112b by inclination surfaces 112c, making it possible to buffer a shock due to deformation of the first stopper protrusions 113 and simultaneously to buffer tension applied when contact is formed between both side surfaces 112a of the receiving portion and the straight contact portions 213b of the second stopper protrusions 213.

Further, a space 140 for accommodating the first stopper protrusions 113 when the first stopper protrusions 113 are deformed is formed between an inner wall surface 111a of the engagement opening and the receiving portion 112, and escaping grooves 240 for accommodating the first stopper protrusions 113 when the first stopper protrusions 113 are deformed are formed in an inside bottom surface of the male connector holder 200.

The female terminal welding portion 110b and the male terminal welding portion 210b are connected to one side end of the female terminal fixing portion 110a and the fixing portion 210a of the male portion through a first welding inclination portion 110c and a second welding inclination portion 210c, respectively.

Accordingly, when the female terminal welding portion 110b and the welding portion 210b of the male terminal are soldered to corresponding boards, respectively, lead moves up along the first welding inclination portion 110c and the second welding inclination portion 210c, thereby making it possible to greatly increase welding force.

Further, the width of the first welding inclination portion 110c is formed to be narrower than that of the female terminal welding portion 110b and that of the female terminal fixing portion 110a and the width of the second welding inclination portion 210c is formed to be narrower than that of the male terminal welding portion 210b and that of the male terminal fixing portion 210a. Through such a construction, when the female connector holder is engaged with the male connector holder 200, the female terminal welding portion 110b and the male terminal welding portion 210b are easily bent in a direction perpendicular to the female terminal fixing portions 110a and the male terminal fixing portions 210a, respectively.

In the meantime, each of both sides of the female terminal fixing portion 110a and the male terminal fixing portion 210a includes at least one first wedge-type protrusion 110d and at least one second wedge-type protrusion 210d, so that the first wedge-type protrusions 110d and the second wedge-type protrusions 210d prevent the female terminal 110 and the male terminal 210 from being separated from the female connector holder 100 and the male connector holder 200, respectively.

In this case, a size of a cross-sectional area of an end of an opposite side of the female terminal fixing portion 110a which is not connected to the female terminal welding portion 110b is gradually decreased in an engagement direction such that the end of the opposite side of the female terminal fixing portion 110a is easily guided to the first fixing groove 115 when the female terminals are engaged with the female connector holder 110.

Further, for the same purpose, a size of a cross-sectional area of one end of an opposite side of the male terminal fixing portion 210a which is not connected to the male terminal welding portion 210b is gradually decreased in the engagement direction.

### Second Embodiment

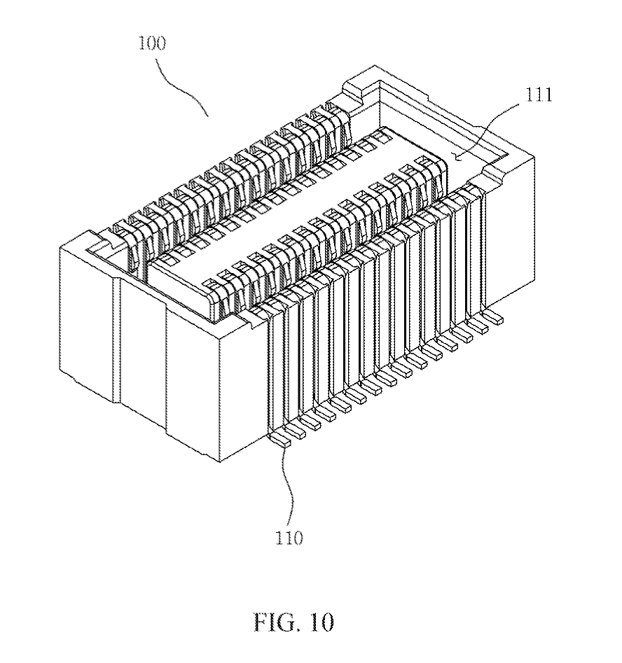

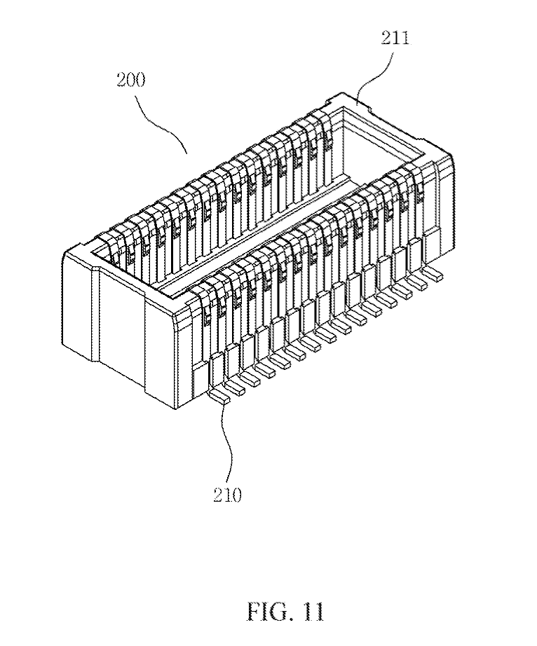

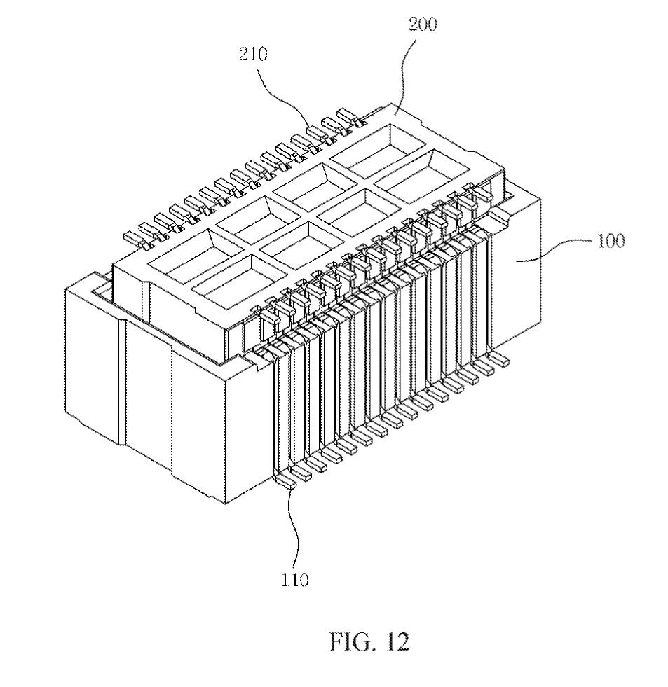

FIGS. 10 and 11 are perspective views illustrating a female connector holder 100 and a male connector holder 200 included in a board-to-board-type connector according to a second embodiment of the present invention, respectively, and FIG. 12 is a perspective view illustrating an engagement state of the female connector holder 100 and the male connector holder 200.

As illustrated in FIGS. 10 to 12, the board-to-board-type connector according to the present invention includes the female connector holder 100 engaged with a plurality of female terminals 110 and the male connector holder 200 engaged with a plurality of male terminals 210.

In this case, the female connector holder 100 is engaged with the plurality of female terminals 110 and has an engagement opening 111 in an upper surface thereof, and the male connector holder 200 is engaged with the female connector holder 100 and engaged with the plurality of male terminals 210 forming electrical contact with the female terminals 110.

Specifically, the male connector holder 200 is fitted to the engagement opening 111 and includes an engagement protrusion 211 protruding a rim of an upper surface thereof and engaged with the plurality of male terminals arranged in symmetrical rows to form the electrical contact with the female terminals 110.

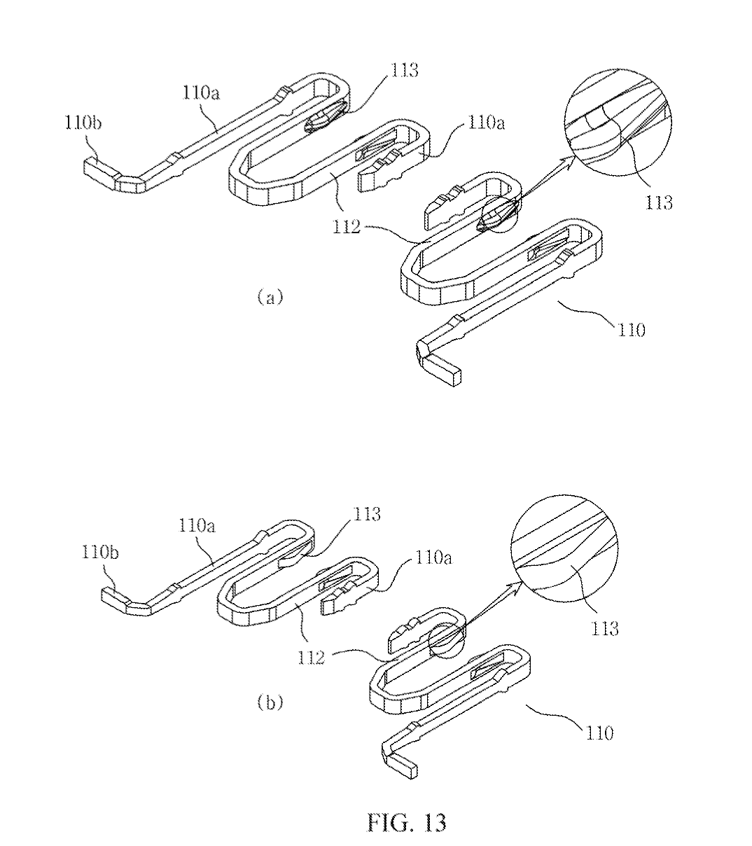

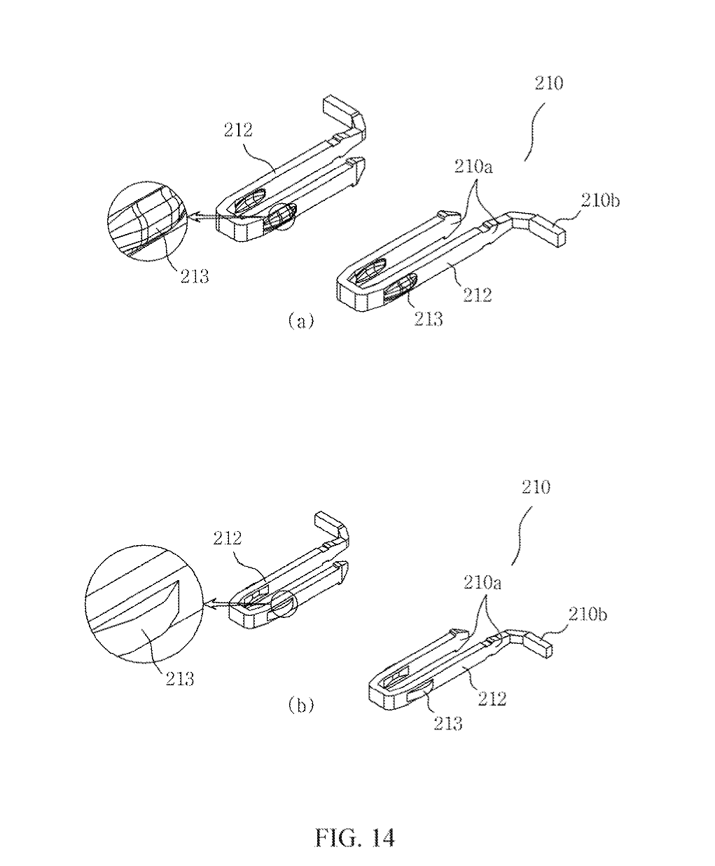

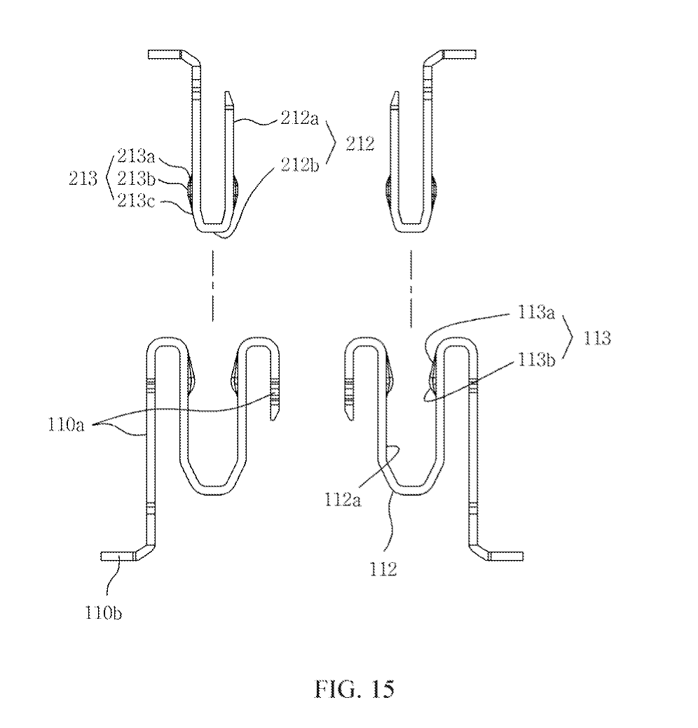

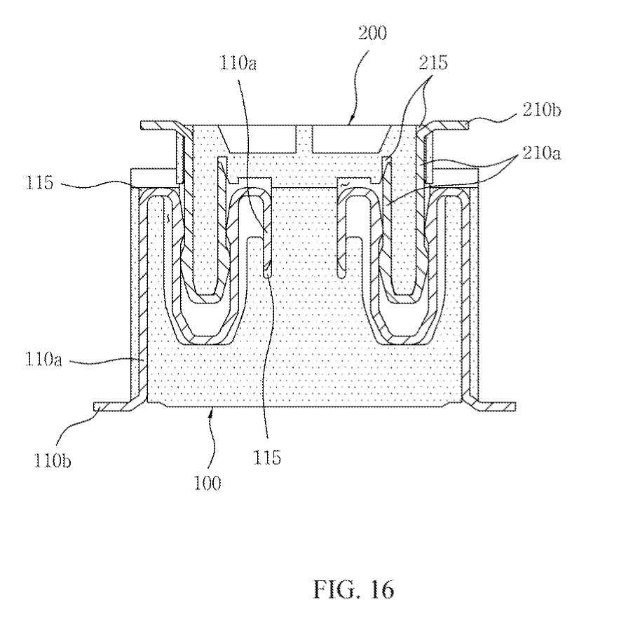

FIGS. 13 and 14 are perspective views illustrating an example of the female terminals 110 and the male terminals 210 of the board-to-board-type connector according to different embodiments of the present invention, respectively, FIG. 15 is a view illustrating a state just before an engagement of the female terminals 110 and the male terminals 210, and FIG. 16 is a cross-sectional view illustrating an engagement of the female terminals 110 and the male terminals 210.

The female terminal 110 included in the board-to-board-type connector according to the present invention includes a U-shaped receiving portion 112 accommodated in the engagement opening 111, first stopper protrusions 113 symmetrically protruding toward the inside of the engagement opening 111 from intermediate portions of both side surfaces of the U-shaped receiving portion 112, female terminal fixing portions 110a extended from both ends of the receiving portion 112 and engaged with first fixing grooves 115 formed in both sides of the engagement opening 111, and a female terminal welding portion 110b perpendicular to the female terminal fixing portions 110a and formed toward the outside of the female connector holder 100.

Further, the first stopper protrusion 113 includes a first inclination portion 113a of which a height protruding from an entrance of the receiving portion 112 in an insertion direction of an insertion portion 212 gradually increases, and a second inclination portion 113b which is extended from the first inclination portion 113a and of which a height protruding in the insertion direction gradually decreases. That is, the first stopper protrusion has a wedge shape.

In this case, a gradient of the first inclination portion 113a is larger than that of the second inclination portions 113b. Through the construction, the board-to-board-type connector according to the present invention requires a small force when the female terminals 110 are engaged with the male terminals 210, but requires a relatively large force when the female terminals 110 are separated from the male terminals 210, so that it is possible to stably maintain the engagement of the female terminals 110 and the male terminals 210.

The male terminal 210 includes a U-shaped insertion portion 212 formed along an outer peripheral surface of the engagement protrusion 211, second stopper protrusions 213 symmetrically protruding toward the outside of the engagement protrusion 211 from the intermediate portions of both sides of the insertion portion 212, male terminal fixing portions 210a extended from both ends of the insertion portion 212 and engaged with second fixing grooves 215 formed at both sides of the engagement protrusion 211, and a male terminal welding portion 210b perpendicular to the male terminal fixing portion 210a and formed toward the outside of the male connector holder 200.

Further, the second stopper protrusion 213 includes a third inclination portion 213a of which a height protruding in the insertion direction of the insertion portion 212 gradually increases, a straight contact portion 213b which is extended from the third inclination portion 213a and is parallel to both side surfaces 212a of the insertion portion, and a fourth inclination portion 213c which connects the straight contact portion 213b and a bottom surface 212b of the insertion portion and of which a height protruding in the insertion direction gradually decreases. That is, the second stopper protrusion 213 has a wedge shape.

In this case, it is preferable that a gradient of the fourth inclination portion 213c is formed to be identical or similar to that of the first inclination portion 113c, so that the insertion portion 212 is inserted into the inside of the receiving portion 112 with a small force when the female terminal 110 is engaged with the male terminal 210.

In the embodiment of the present invention, as illustrated in FIGS. 13 and 14, the first stopper protrusions 113 protrude from the outside surfaces of both sides of the receiving portion 112 toward respective inside facing surfaces of the receiving portion 112 through a bending, an embossing, or a slitting processing, and the second stopper protrusions 213 protrude from the inside facing surfaces of the insertion portion 212 toward the outside surfaces of both sides of the insertion portion 212 through a bending, an embossing, or a slitting processing.

In addition, the first stopper protrusions 113 and the second stopper protrusions 213 may be formed by a known press processing, such as a punching, of creating burrs in the plate-type receiving portion 112 and insertion portion 212 before the bending. Further, the first stopper protrusions 113 and the second stopper protrusions 213 may be separately formed as separated components and then may be attached to the receiving portion 112 and the insertion portion 112 through a welding.

Through the aforementioned construction, the contact of the first stopper protrusions 113 with the insertion portion and the contact of the second stopper protrusions 213 with the receiving portion 112 by the elastic deformation of the receiving portion 112 and the insertion portion 212 make the female terminals 110 and the male terminals 210 be strongly engaged with each other when the female connector holder is fitted to the male connector holder. In this case, the female terminals 110 may be strongly engaged with the male terminals 210 by a tension according to the elastic deformation.

In addition, the first stopper protrusions 113 and the second stopper protrusions 213 are bilaterally symmetrical, respectively, and thus the female terminals 110 and the male terminals 210 come to be in a completely locked state when the female connector holder is fitted to the male connector holder.

That is, the female terminals 110 and the male terminals 210 have a notch structure of the first and second stopper protrusions formed by the embossing or slitting processing, so that the engagement force becomes stronger when the female terminals 110 are engaged with the male terminals 210.

In addition, when the first stopper protrusions 113 are engaged with the second stopper protrusions 213, the first inclination portions of the first stopper protrusion come into contact with the fourth inclination portions of the second stopper protrusion so that the first stopper protrusions 113 are symmetrically engaged with the second stopper protrusions 213.

Meanwhile, the first stopper protrusions 113 and the second stopper protrusions 213 formed by the slitting processing will be described in more detail. As illustrated in FIGS. 6B and 7B, the first stopper protrusions 113 and the second stopper protrusions 213 include incision portions (not shown) such that both side surfaces thereof are interconnected, and thus the first stopper protrusions 113 and the second stopper protrusions 213 have a bent plate shape to autonomously have elasticity.

Accordingly, since the first stopper protrusions 113 and the second stopper protrusions 213 autonomously have elasticity, the female terminals 110 and the male terminals 210 are elastically compressed and then restored when the female terminals 110 are fitted to the male terminals 210, thereby further enhancing the engagement of the female terminals 110 and the male terminals 210.

Accordingly, the female terminal 110 and the male terminal 210 of the board-to-board-type connector according to the present invention are attached/detached to/from each other by the elastic deformation of the U-shaped receiving portion 112 including the first stopper protrusions 113 and the U-shaped insertion portion 212 including the second stopper protrusions 213.

That is, when the female terminal 110 is engaged with the male terminal 210, the bottom surface 212b and the fourth inclination portions 213c of the male terminal 210 are naturally guided into the inside of the receiving portion 112 along the first inclination portions 113a of the first stopper protrusions 113 of the female terminal 110 so that the receiving portion 112 of the female terminal 110 is widened in left and right directions, and when the second stopper protrusions 213 are completely inserted into the inside of the receiving portion 112, the receiving portion 112 returns to their original position by elasticity.

A width between the first stopper protrusions 113 facing each other in the inside surface of the receiving portion 112 is narrower than a width between both side surfaces 212a of the insertion portion, so that when the second stopper protrusions 213 pass through the first stopper protrusions 113, the first stopper protrusions 113 widened in both side directions impact with both side surfaces 212a of the insertion portion while instantly returning to their original positions by elasticity to generate impact sound.

Therefore, the click feeling when the female terminals 110 are engaged with the male terminals 210 is improved by the impact sound, so that a user can advantageously identify whether the female terminals 110 are normally engaged with the male terminals 210.

Further, when the female terminal 110 is separated from the male terminal 210, the third inclination portions 213a of the male terminal 210 are guided along the second inclination portions 113b having a relatively large gradient, so that the separation of the female terminal 110 from the male terminal 210 requires a larger force than a force required for the engagement of the female terminal 110 and the male terminal 210. As a result, the board-to-board-type connector according to the present invention can stably maintain the engagement state of the female terminals 110 and the male terminals 210.

Further, as described above, the board-to-board-type connector according to the present invention has a construction in which the female terminals 110 are symmetrically deformed in left and right directions when the female terminals 110 are attached/detached to/from the male terminals 210, so that stresses applied to the female terminals 110 when the female terminals 110 are attached/detached to/from the male terminals 210 is distributed in right and left directions.

Accordingly, since stresses applied to each of the first stopper protrusions 113 and the receiving portion 112 in both sides are greatly decreased compared to the conventional art, elasticity of the female terminals 110 and the male terminals 210 is advantageously maintained when the board-to-board-type connector is used for a long time, thereby making it possible to stably maintain the electrical contact between the female terminals 110 and the male terminals 210.

In the embodiment of the present invention, the width between the straight contact portions 213b is formed to be identical to or slightly larger than a width between inside facing surfaces 112a of the receiving portion, so that the board-to-board-type connector according to the present invention may doubly form electrical contact between the inside surfaces 112a of the receiving portion and the straight contact portions 213b of the second stopper protrusions 213 and between the first stopper protrusions 113 and both side surfaces 212a of the insertion portion.

Although a preferred embodiment of the present invention has been described for illustrative purposes, those skilled in the art will appreciate that various modifications, additions and substitutions are possible, without departing from the scope and spirit of the invention as disclosed in the accompanying claims.

For example, at least two stopper protrusions may be formed in the inside facing surfaces of the receiving portion 112 and the stopper grooves in a number corresponding to the number of the stopper protrusions are formed in the outside surfaces of the insertion portion 212 such that the stopper protrusions are inserted into the stopper grooves.

Further, contrary to the above example, at least two stopper grooves are formed in the inside facing surfaces of the receiving portion 112 and the stopper protrusions in a number corresponding to the number of stopper grooves are formed in the outside surface of the insertion portion 212 such that the stopper protrusions are inserted into the stopper grooves.

What we claim is:

1. A board-to-board-type connector comprising:
a female connector holder having an engagement opening in an upper surface with which a plurality of female terminals are engaged in symmetrical rows; and
a male connector holder having an upper rim from which an engagement protrusion protrudes such that a plurality of male terminals are arranged in symmetrical rows and engaged with the engagement protrusion to form electrical contact with the female terminals, the male connector holder being fitted to the engagement opening of the female connector holder,
wherein the female terminal comprises a U-shaped receiving portion accommodated in the engagement opening and first stopper protrusions symmetrically protruding toward an inside of the engagement opening from intermediate portions of both side surfaces of the receiving portion,
the male terminal comprises a U-shaped insertion portion formed along an outer peripheral surface of the engagement protrusion and second stopper protrusions symmetrically protruding toward an outside direction of the engagement protrusion from intermediate portions of both side surfaces of the insertion portion, and
the female terminals are attached/detached to/from the male terminals by elastic deformation of the first stopper protrusions and the second stopper protrusions.

2. The board-to-board-type connector as claimed in claim 1, wherein the first stopper protrusion has a first inclination portion of which a height protruding from an entrance of the receiving portion in an insertion direction of the insertion portion gradually increases and a second inclination portion which is extended from the first inclination portion and of which a height protruding in the insertion direction gradually decreases, and widths between contact points of the first inclination portions and the second inclination portions are narrower than a width between the both side surfaces of the insertion portion, and a gradient of the second inclination portion is larger than that of the first inclination portion.

3. The board-to-board-type connector as claimed in claim 2, wherein a space is formed between an inside wall surface of the engagement opening and the receiving portion such that the first stopper protrusions can be easily deformed when the female connector holder is fitted to the male connector holder.

4. The board-to-board-type connector as claimed in claim 3, wherein the both side surfaces of the receiving portion are connected to a bottom surface of the receiving portion by inclination surfaces so as to buffer a shock due to deformation of the first stopper protrusions.

5. The board-to-board-type connector as claimed in claim 2, wherein the second stopper protrusion has a third inclination portion of which a height protruding in the insertion direction of the insertion portion gradually increases, a straight contact portion which is extended from the third inclination portion in a direction parallel to the both side surfaces of the insertion portion, and a fourth inclination portion which connects the straight contact portion and a bottom surface of the insertion portion and of which a height protruding in the insertion direction gradually decreases, and
when the female connector holder is fitted to the male connector holder, electrical contacts are formed between the both side surfaces of the receiving portion and the straight contact portions of the second stopper protrusions and between the first stopper protrusions and the both side surfaces of the insertion portion.

6. The board-to-board-type connector as claimed in claim 1, wherein the female terminal further comprises female terminal fixing portions extended from both ends of the receiving portion and engaged with first fixing grooves formed in both sides of the engagement opening and a female terminal welding portion perpendicular to the female terminal fixing portions and formed toward an outside of the female connector holder, and
the female terminal welding portion is connected to an end of one side of the female terminal fixing portion through a first welding inclination portion and a width of the first welding inclination portion is narrower than a width of the female terminal welding portion and a width of the female terminal fixing portion.

7. The board-to-board-type connector as claimed in claim 6, wherein the female terminal fixing portion includes at least one first wedge-type protrusion in each of both sides thereof for preventing the female terminal from being separated from the female connector holder, and
in order to guide an end of an opposite side of the female terminal fixing portion which is not connected with the female terminal welding portion to the first fixing groove when the female terminal is engaged with the female connector holder, a size of a cross-sectional area of the end of the opposite side of the female terminal fixing portion gradually decreases in an engagement direction.

8. The board-to-board-type connector as claimed in claim 1, wherein the male terminal further comprises male terminal fixing portions extended from both ends of the insertion portion and engaged with second fixing grooves formed in both sides of the engagement protrusion and a male welding portion perpendicular to the male terminal fixing portions and formed toward the outside of the male connector holder, and
the male terminal welding portion is connected to an end of one side of the male terminal fixing portion through a second welding inclination portion and a width of the second welding inclination portion is narrower than a width of the male terminal welding portion and a width of the male terminal fixing portion.

9. The board-to-board-type connector as claimed in claim 8, wherein the male terminal fixing portion includes at least one second wedge-type protrusion in each of both sides thereof for preventing the male terminal from being separated from the male connector holder, and
in order to guide an end of an opposite side of the male terminal fixing portion which is not connected to the male terminal welding portion to the second fixing groove when the female terminal is engaged with the female connector holder, a size of a cross sectional area of the end of the opposite side of the male terminal fixing portion gradually decreases in an engagement direction.

10. The board-to-board-type connector as claimed in claim 1, wherein each of the engagement opening and the engagement protrusion has a □-shape, and
a curve or a straight chamfer for guiding the engagement protrusion to the engagement opening when the female connector holder is fitted to the male connector holder is formed in a rim of the engagement opening with which the female terminals are not engaged or a rim of the engagement protrusion with which the male terminals are not engaged.

11. The board-to-board-type connector as claimed in claim 10, wherein stepped portions are vertically and inwardly formed in outside surfaces of the female connector holder with which the female terminals are not engaged and outside surfaces of the male connector holder with which the male terminals are not engaged, respectively.

12. The board-to-board-type connector as claimed in claim 1, wherein the male connector holder has escaping grooves in an inside bottom surface of the male connector holder for accommodating deformation of the female terminals when the female connector holder is fitted to the male connector holder.

13. The board-to-board-type connector as claimed in claim 1, wherein the first stopper protrusions protrude from the outside surfaces of both sides of the receiving portion toward inside surfaces of each of the outside surfaces of the receiving portion such that the first stopper protrusions symmetrically face each other through a bending, an embossing, or a slitting processing, and the second stopper protrusions protrude from the inside facing surfaces of the insertion portion toward the outside surfaces of both sides of the insertion portion such that the second stopper protrusions symmetrically face each other through a bending, an embossing, or a slitting processing, and
the female terminal comes into contact with the male terminal by elastic deformation of the receiving portion and the insertion portion, wherein the first stopper protrusions come into contact with the insertion portion and the second stopper protrusions come into contact with the receiving portion.

14. The board-to-board-type connector as claimed in claim 13, wherein the first stopper protrusion has a first inclination portion of which a height protruding from an entrance of the receiving portion in an insertion direction of the insertion portion gradually increases and a second inclination portion which is extended from the first inclination portion and of which a height protruding in the insertion direction gradually decreases, and
a width between the facing first stopper protrusions formed in the inside surfaces of the receiving portion is narrower than a width between the both side surfaces of the insertion portion, and the first stopper protrusion has a wedge shape such that a gradient of the second inclination portion is larger than that of the first inclination portion.

15. The board-to-board-type connector as claimed in claim 14, wherein the second stopper protrusion has a third inclination portion of which a height protruding in the insertion direction of the insertion portion gradually increases, a straight contact portion which is extended from the third inclination portion in a direction parallel to the both side surfaces of the insertion portion, and a fourth inclination portion which connects the straight contact portion and of which a height protruding in the insertion direction gradually decreases to have a wedge shape, and
a gradient of the fourth inclination portion is identical to that of the first inclination portion, and electrical contacts are formed between the inside surfaces of the receiving portion and the straight contact portions of the second stopper protrusions and between the first stopper protrusions and the both side surfaces of the insertion portion when the female connector holder is fitted to the male connector holder.

16. The board-to-board-type connector as claimed in claim 15, wherein when the first stopper protrusions are engaged with the second stopper protrusions by the engagement of the female terminals and the male terminals, the first inclination portions of the first stopper protrusion are in contact and symmetrically engaged with the fourth inclination portions of the second stopper protrusion.

17. The board-to-board-type connector as claimed in claim 15, wherein the first stopper protrusion and the second stopper protrusion have incision portions formed by a slitting processing such that both side surfaces of the first stopper protrusion and the second stopper protrusion are interconnected.
